(19) United States
(12) Patent Application Publication
(10) Pub. No.: US 2008/0172710 A1
(43) Pub. Date: Jul. 17, 2008

(54) METHOD OF IMPROVING CHANNEL SWITCHING SPEED IN DIGITAL TELEVISION RECEIVER AND THE DIGITAL TELEVISION RECEIVER

(75) Inventors: Hee-beom KANG, Hwaseong-si (KR); Kang-wook CHUN, Hwasung-si (KR); Choon-sik JUNG, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/778,683

(22) Filed: Jul. 17, 2007

(30) Foreign Application Priority Data
Jan. 12, 2007 (KR) 10-2007-0003974

(51) Int. Cl. H04N 7/24

(52) U.S. Cl. 725/118

(57) ABSTRACT

Provided is a method of improving a channel switching speed in a digital television (TV) receiver. The method includes: generating transport stream packets by channel tuning and demodulating a broadcasting signal of a channel selected by the channel change instruction;
outputting the transport stream packets before completion of tuning and demodulating of the broadcast signal; and
generating video and/or audio data by demultiplexing and decoding the outputted transport stream packets. In addition, a digital TV receiver applying the improvement of the channel switching speed is provided. The digital TV receiver includes a tuning and demodulating unit generating transport stream packets by tuning and demodulating a broadcasting signal of a broadcasting channel selected by a channel change instruction and outputting the transport stream packets before completion of the tuning and demodulation of the transport stream packets. The digital TV receiver starts screen mute in response to the channel change instruction and terminates the screen mute when a normal image display is possible by using the transport stream packets output from the tuning and demodulating unit. Therefore, the channel switching speed increases as compared with a case where the improvement of the channel switching speed is attempted by using the transport stream packets.

### CROSS-REFERENCE TO RELATED PATENT APPLICATION

This application claims the benefit of Korean Patent Application No. 10-2007-0003974, filed on Jan. 12, 2007, in the Korean Intellectual Property Office, the disclosure of which is incorporated herein in its entirety by reference.

### BACKGROUND OF THE INVENTION

1. Field of the Invention

The present invention relates to channel switching in a digital television (TV) receiver, and more particularly, to a method of improving a broadcasting channel switching speed in a digital TV receiver and the digital TV receiver for improving the broadcasting channel switching speed.

2. Description of the Related Art

Recently, as digital television (TV) broadcasting has been actively developed, users of digital TV receivers continuously increase. However, when the digital TV receiver is used, there is a problem in that time consumed to switch a broadcasting channel is longer than that consumed in an analog TV receiver.

FIG. 1 shows an example of time consumed from inputting a channel change instruction by a user to normally displaying a picture in a conventional digital TV receiver. When the user wants to change a broadcasting channel, the digital TV receiver changes a current picture to a different picture corresponding to a selected channel. In order to avoid screen flicking when the current picture is switched to the different picture due to the broadcasting channel switching, setting the screen to a black level for a predetermined period while switching images, that is, so-called screen mute is employed. The period needed to switch the broadcasting channel includes a time period 0.09 sec from inputting the channel change instruction to mute on, a time period 0.63 sec for channel tuning including synchronization, equalization, forward error correction (FEC), and the like, a time period 0.5 sec for transport stream demultiplexing and sequence head searching, and a time period 0.49 sec from decoding an elementary stream to mute off. As shown in FIG. 1, the conventional digital TV broadcasting receiver needs a predetermined period of about 2 sec to switch the broadcasting channel.

A technique in a conventional example to improve a channel change speed in a digital TV receiver is disclosed in Korea Patent Publication No. 2001-81402 (conventional example 1). According to the conventional example 1, a transport stream output from a vestigial sideband (VSB) demodulator when channel changing is monitored to collect program identification (ID) information, and the result of the collecting is output as a current program ID information. When previous program ID information stored in advance and the current program ID information are coincident, the previous program ID information is set as program ID information for a program of a changed channel. When the previous program ID information and the current program ID information are not coincident, the current program ID information is set as program ID information for the program of the changed channel. When such program ID information set as described above is used, time consumed to find an audio/video packet ID can be shortened, and as a result, a period consumed to obtain an elementary stream by demultiplexing the transport stream can also be shortened.

Another technique is disclosed in Korea Patent Publication No. 2006-88646 (conventional example 2). A digital TV receiver in the conventional example 2 determines whether a packet ID (PID) parsed from a transport stream obtained as a result of performing turning and VSB demodulation for a channel to be changed is coincident with a stored PID. When the parsed PID is coincident with the stored PID, video/audio data is extracted according to audio/video PID information set corresponding to the stored PID. Otherwise, an audio/video PID is set by using a new PID, and then, audio/video data is extracted according to the set audio/video PID. Therefore, when the parsed PID is coincident with the stored PID, time to set the audio/video PID is not needed, so that an improvement of the channel change speed is achieved.

Both the conventional examples 1 and 2 are planed to improve the channel change speed by using the transport stream output from the demodulator. Different existing digital TV receivers are also using transport stream processing in order to improve the channel change speed.

However, in the existing digital TV receivers, only when a signal-to-noise ratio (SNR) of a transport stream packet is higher than an SNR value set in advance, the demodulator supplies the transport stream to the demultiplexer. The demultiplexing and sequence header searching starts only after the point in time in which the demodulator supplies the transport stream to the demultiplexer. Therefore, there is certainly scope for improvement in the channel change speed in relation to data processing of the demodulator for outputting the transport stream.

### SUMMARY OF THE INVENTION

The present invention provides a method of switching channel capable of performing demultiplexing and decoding on a transport stream having unfinished error correction and thus rapidly completing the channel switching as compared with a case where a transport stream without errors is used.

The present invention also provides a digital broadcasting receiver in which the aforementioned method of switching a channel is implemented.

According to an aspect of the present invention, there is provided a method of switching a channel in a digital broadcasting receiver, the method comprising: (a) starting screen mute in response to a channel change instruction;

(b) generating transport stream packets by channel tuning and demodulating a broadcasting signal of a channel selected by the channel change instruction and outputting the transport stream packets before the completion of the channel tuning and demodulation of the broadcast signal;

(c) generating video and audio data by demultiplexing and decoding the transport stream packets output in (b); and

(d) when a normal image display is possible due to the video data generated in (c), terminating the screen mute.

According to another aspect of the present invention, there is provided a digital broadcasting receiver comprising: a tuning and demodulating unit generating transport stream packets by tuning and demodulating a broadcasting signal of a broadcasting channel selected by a channel change instruction and outputting the transport stream packets before the completion of the channel tuning and demodulation of the broadcast signal;

a data processing unit generating video and audio data by demultiplexing and decoding the transport stream packets output from the tuning and demodulating unit; and

a reproducing unit reproducing the video and audio data,

wherein the digital broadcasting receiver starts screen mute in response to the channel change instruction and terminates the screen mute when a normal image display is possible by using the video data.

The above-mentioned and other objectives, characteristics and advantages of the present invention will be obvious to those of ordinary skill in the art by descriptions to be later described with reference to the accompanying drawings.

### BRIEF DESCRIPTION OF THE DRAWINGS

The above and other features and advantages of the present invention will become more apparent by describing in detail exemplary embodiments thereof with reference to the attached drawings in which:

FIG. 1 is a conceptual view for explaining time consumed from inputting a channel change instruction by a user to normally displaying a picture in a conventional digital television (TV) receiver;

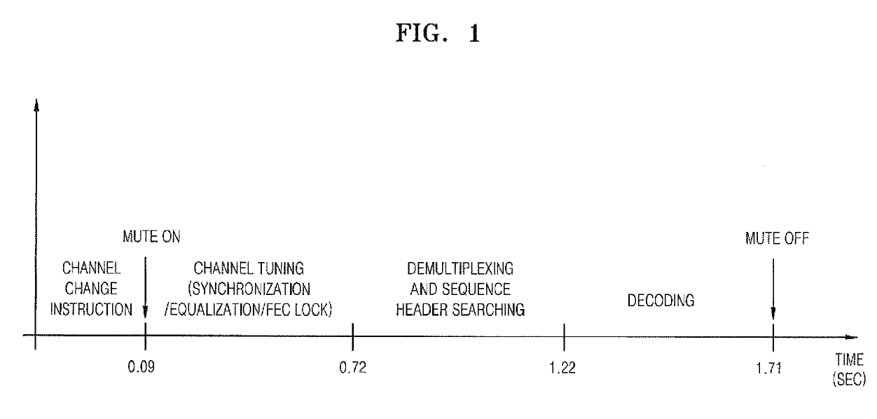

FIG. 2 is a block diagram showing a digital TV receiver in which a method of improving a channel switching speed is implemented according to an embodiment of the present invention;

FIG. 3 is a flowchart for explaining operations of improving a channel switching speed of the digital TV receiver shown in FIG. 2; and

FIG. 4 is a conceptual view showing a method of improving a channel switching speed by comparing the method with a conventional technology according to an embodiment of the present invention.

### DETAILED DESCRIPTION OF THE INVENTION

Hereinafter, exemplary embodiments of the present invention will be described in detail with reference to the attached drawings.

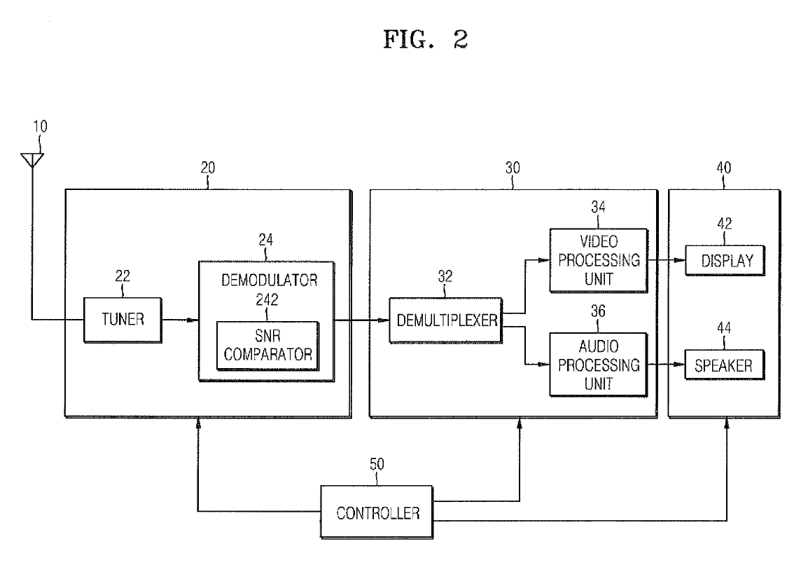

FIG. 2 is a block diagram showing a digital television (TV) receiver in which a method of improving a channel switching speed is implemented according to an embodiment of the present invention. Referring to FIG. 2, the digital TV receiver includes an antenna 10, a tuning and demodulating unit 20, a data processing unit 30, and a reproducing unit 40, which are connected in a listed order.

The tuning and demodulating unit 20 generates transport stream packets by tuning and demodulating a broadcasting signal of a broadcasting channel selected by a channel change instruction and outputs the transport stream packets to the data processing unit 30 even when the transport stream packets have errors therein. The tuning and demodulating unit 20 includes a tuner 22 and a demodulator 24. The tuner 22 performs a tuning operation on the broadcasting channel selected by the channel change instruction and outputs the broadcasting signal of the broadcasting channel received by the tuning operation to the demodulator 24. The demodulator 24 demodulates the broadcasting signal output from the tuner 22 to generate the transport stream packets. For example, the demodulator 24 performs vestigial sideband (VSB) demodulation on the received broadcasting signal to generate a moving picture experts group-2 (MPEG-2) transport stream. The MPEG-2 transport stream includes the transport stream packets. Even when there exists greater chance of errors in the generated transport stream packets, the demodulator 24 outputs the transport stream packets to the data processing unit 30. For this, the demodulator 24 includes a signal-to-ratio (SNR) comparator 242. The SNR comparator 242 in the demodulator 24 compares an SNR value corresponding to each transport stream packet with a second SNR threshold (SNR_TH2). That is, the second SNR threshold (SNR_TH2) which is lower in value than the conventionally used first SNR threshold (SNR_TH1) may be used. Typically, a value of 30 db is used for the first SNR threshold value. The demodulator 24 determines whether to output the transport stream packets to the data processing unit 30 according to the result of the comparing of the SNR comparator 242.

The data processing unit 30 generates video and audio data by demultiplexing and decoding the transport stream packets output from the tuning and demodulating unit 20. The data processing unit 30 decodes an elementary stream by using sequence headers included in the elementary stream. The data processing unit 30 includes a demultiplexer 32, a video processing unit 34, and an audio processing unit 36. The demultiplexer 32 generates the elementary stream by demultiplexing the transport stream packets output from the tuning and demodulating unit 20. When the MPEG-2 transport stream is demultiplexed, a packetized elementary stream is obtained. The video and audio processing units 34 and 36 generate video and audio data by decoding the elementary stream output from the demultiplexer 32. The video processing unit 34 processes a video elementary stream to generate the video data, and the audio processing unit 36 processes an audio elementary stream to generate the audio data. The video and audio data are supplied to the data processing unit 30.

The reproducing unit 40 receiving the video and audio data from the data processing nit 30 includes a display 42 and a speaker 44. The display 42 displays images by reproducing the video data. The speaker 44 regenerates sounds by reproducing the audio data.

The aforementioned components in FIG. 2 are controlled by a controller 50.

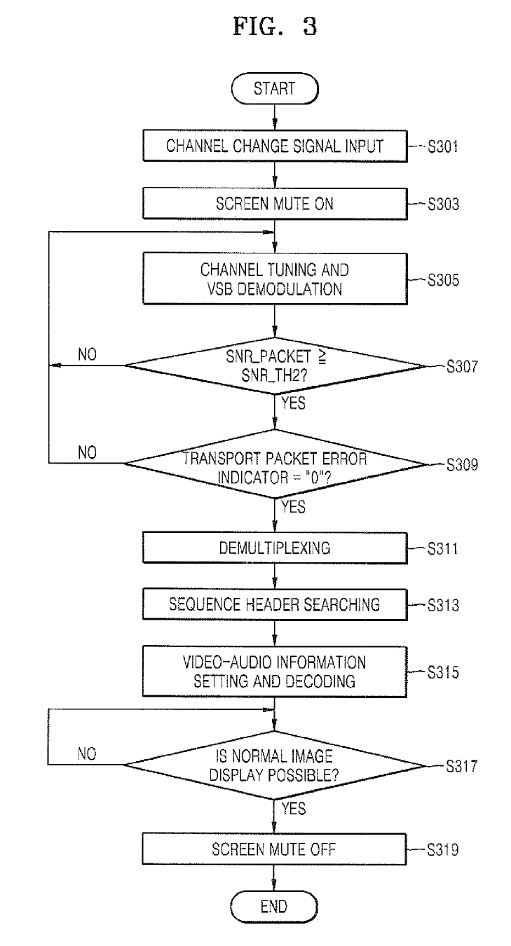

FIG. 3 is a flowchart for explaining a method of improving a channel switching speed of a digital TV receiver according to an embodiment of the present invention. Operations of the components of the digital TV receiver shown in FIG. 2 are described in detail with reference to FIG. 3.

When a channel change instruction is input by a user (operation S301), the digital TV receiver shown in FIG. 2 starts screen mute and channel switching operations. In operation S303, the controller 50 performs a “screen mute on” operation. During operation S303, the controller 50 controls the reproducing unit 40 to allow the display 42 to display a blank signal or a black level signal on the screen and/or the speaker 44 to be in a mute state. In the description, a term “screen mute” is used. This is because the term “screen mute” has been widely used and is needed for the convenience of description. In operation S305, the controller 50 controls the tuning and demodulating unit 20 to perform channel tuning and demodulation. During operation S305, the tuner 20 performs tuning in order to detect an analog TV broadcasting signal which is optimal for the broadcasting channel selected from among signals that can be received through the antenna 10. The tuner 22 outputs the tuned TV broadcasting signal to the demodulator 24. After starting the tuning operation for the selected broadcasting channel, the tuner 22 outputs the analog broadcasting signal received by the tuning operation to the demodulator 24 even when the optimal signal for the selected broadcasting channel is not received.

The demodulator 24 performs the VSB demodulation on the broadcasting signal output from the tuner 22 to generate transport stream packets. When the transport stream packets are generated, the demodulator 24 performs operations of operation S307. In operation S307, the SNR comparator 242 in the demodulator 24 compares an SNR value of each transport stream packet with the second SNR threshold (SNR_TH2). The demodulator 24 then determines whether to output the transport stream packets to the data processing unit 30 according to the result of the comparing of the SNR comparator 242. The second SNR threshold (SNR_TH2) is smaller than the first SNR threshold (SNR_TH1) used conventionally and is a reference value used to allow the transport stream packets to be output to the data processing unit 30. Thus, the transport stream packets are output to the data processing unit 30 even though the channel tuning and the demodulation of the broadcast signal is not completed (before the SNR value (SNR_PACKET) of the transport stream packet reach the first SNR threshold (SNR_TH1)), as long as the second SNR threshold is reached. If the SNR value (SNR_PACKET) of the transport stream packet is less than the second SNR threshold (SNR_TH2), the tuner 22 continues tuning for the selected broadcasting channel, and the demodulator 24 demodulates the broadcasting signal output from the tuner 22 and repeats the operation of determining whether to output the generated transport stream packets. Namely, operations S305 to S307 are repeated. In operation S307, when the SNR value (SNR_PACKET) of each transport stream packet is larger than the second SNR threshold (SNR_TH2), the demodulator 24 outputs the transport stream packets to the data processing unit 30.

The transport stream packet has a transport packet error indicator representing whether the transport stream packet contains errors. The transport packet error indicator may be represented as “transport_errror_indicator”. The transport packet error indicator may be represented as 1-bit flag and is determined during the Reed Solomon decoding process. Since the transport streams packet error indicator will be understood by those skilled in the art, detailed description is omitted.

When the transport stream packets including the transport packet error indicators are supplied to the data processing unit 30, the data processing unit 30 performs operations of operation S309. In operation S309, the demultiplexer 32 in the data processing unit 30 determines whether to perform a demultiplexing operation on a transport stream packet based on a transport packet error indicator included in the transport stream packet. More specifically, the demultiplexer 32 determines whether the transport packet error indicator represents that the transport stream packet has errors. When a value of the transport packet error indicator is 0 (not having error), the demultiplexer 32 determines that the transport stream packet corresponding to the transport packet error indicator is a demultiplexable transport stream packet. On the contrary, when the value of the transport packet error indicator is 1, the demultiplexer 32 determines that the corresponding transport stream packet corresponding to the transport packet error indicator is not a demultiplexable transport stream packet. When the value of the transport packet error indicator is 1, the demultiplexer 32 waits the demultiplexing operation until the value of the transport packet error indicator becomes 0. Therefore, the operations in operations S305 to S309 are repeated until a transport stream packet having a transport packet error indicator with a value of 0 is supplied to the demultiplexer 32.

When the transport stream packet having the transport packet error indicator with the value of 0 is supplied to the demultiplexer 32, the demultiplexer 32 demultiplexes the transport stream packets to generate a packetized elementary stream (operation S311). The demultiplexer 32 uses a packet identification (PID) during the demultiplexing for the transport stream packets. This is because transports stream packets corresponding to an elementary stream have the same PID. It will be understood by those skilled in the art that the elementary stream is generated by demultiplexing the transport stream packets using the PID, so that detailed description will be omitted. The demultiplexer 32 demultiplexes the transport stream packets to generate a video elementary stream and an audio elementary stream. The video elementary stream is supplied to the video processing unit 34, and the audio elementary stream is supplied to the audio processing unit 36.

The video and audio processing units 34 and 36 search for sequence headers included in the elementary streams (operation S313), set video and audio information by using the information on the found sequence headers, and decode the video and audio elementary streams (operation S315). Examples of the information included in the sequence header may include horizontal and vertical sizes of an image, an aspect ratio, and a frame rate. The video and audio processing units 34 and 36 output video and audio data obtained as the result of the decoding to the reproducing unit 40.

The reproducing unit 40 determines whether a normal image display is possible based on the received video data (operation S317). For example, when images can be continuously reproduced for a predetermined period, the reproducing unit 40 may determine that the normal image display is possible. Differently, when the number of image frames is more than a predetermined number, it may be determined that the normal image display is possible. In operation S317, when it is determined that the normal image display is not possible, the reproducing unit 40 repeats the operation of determining whether the normal image display is possible for the video data supplied from the video processing unit 34. When it is determined that the normal image display is possible, the reproducing unit 40 performs a screen mute off operation (operation S319). The display 42 of the reproducing unit 40 then displays images, and the speaker 44 reproduces sounds. When information on the screen mute off is needed for the controller 50, the reproducing unit 40 notifies the controller 50 of the information when the screen mute off is performed.

In the current embodiment, it is described that reproducing unit 40 performs the screen mute off operation. However, the present invention is not limited to the description. Differently, the reproducing unit 40 may inform the controller 50 that the normal image display is possible, and the controller 40 may control the display 42 and the speaker 44 in the reproducing unit 40 to allow them to perform the screen mute operation.

Differently, the data processing unit 30 may determine whether the normal image display is possible, and only when it is determined that the normal image display is possible, the video and audio data may be supplied to the reproducing unit 40.

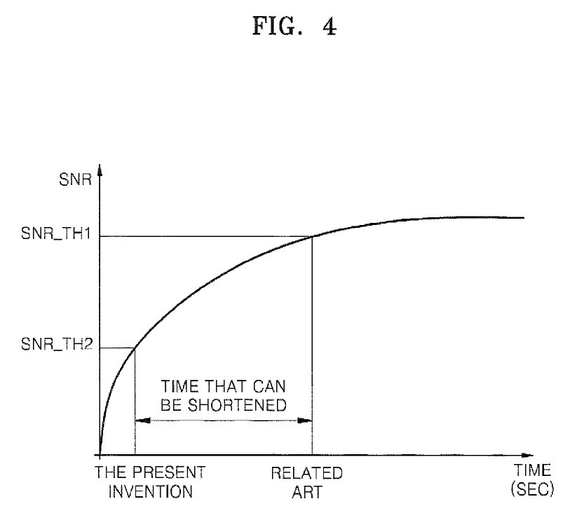

FIG. 4 is a conceptual graph showing time consumed for channel switching according to a related art and time consumed for channel switching according to an embodiment of the present invention. A curve in FIG. 4 shows a change in an SNR after channel tuning is started. “Time that can be shortened” shown in FIG. 4 may be changed according to a value of the second SNR threshold (SNR_TH2). According to the related art, transport streams are demultiplexed and decoded only when an SNR of a transport stream packet satisfies an SNR threshold set in advance. In this related art, in order to increase the SNR of the transport stream packet to more than the SNR threshold set in advance, channel lock has to be achieved. Therefore, it takes much time from inputting the channel change instruction to achieving the channel lock. On the contrary, according to the embodiment of the present invention, transport stream packets are demultiplexed and decoded even when the SNRs of the transport stream packets are smaller than the conventionally used first SNR threshold. Thus, the second SNR threshold value (SNR_TH2) may be set to various values smaller than the first SNR threshold value (SNR_TH1) including a value of substantially 0. For example, when the digital TV receiver is located at an area where a signal reception status is good and when the second SNR threshold (SNR_TH2) is set to substantially 0, images obtained by demultiplexing and decoding transport stream packets having errors can be possibly displayed. Therefore, even in a situation where the channel lock is not achieved, the normal image display is possible. Typically, the second SNR threshold value (SNR_TH2) may be set to 20, 15, 10 or 5 db values. According to the embodiment of the present invention, even in the worst case, the normal image display is intermittently possible. Therefore, the user can more rapidly determine whether a broadcasting program of the selected broadcasting channel provides desired images as compared with the related art.

As described above, according to the embodiment of the present invention, even when errors exist in the broadcasting signal, the transport stream can be demultiplexed and decoded. Accordingly, demultiplexing and decoding the transport stream need not be delayed until an optimal signal is obtained in the tuning and VSB demodulation operation. Therefore, time consumed from the screen mute on to the screen mute off while channel switching is shortened, so that there is an advantage in that convenience of the user increases.

While the present invention related to the digital TV receiver has been particularly shown and described with reference to exemplary embodiments thereof, it will be understood by those skilled in the art that a digital broadcasting receiver which uses the tuning and demodulation technique and has a different type such as a personal multimedia player (PMP), a personal digital assistant (PDA), a mobile terminal, and a settop box may be employed by the present invention. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of switching a channel in a digital broadcasting receiver, the method comprising:
(a) starting screen mute in response to a channel change instruction;
(b) generating transport stream packets by channel tuning and demodulating a broadcasting signal of a channel selected by the channel change instruction and outputting the transport stream packets before the completion of the channel tuning and demodulation of the broadcast signal;
(c) generating video and audio data by demultiplexing and decoding the transport stream packets output in (b); and
(d) when a normal image display is possible due to the video data generated in (c), terminating the screen mute.

2. The method of claim 1, wherein in (b), even when a SNR (signal-to-ratio) value of the transport stream packet is smaller than a first SNR threshold, the transport stream packets are output, and the first SNR threshold is a reference value used to determine that the channel tuning and demodulation of the broadcast signal has been completed.

3. The method of claim 2, wherein (b) comprises:
(b1) comparing an SNR value corresponding to each transport stream packet with a second SNR threshold; and
(b2) when the SNR value corresponding to the transport stream packet is larger than the second SNR threshold, starting to output the transport stream packets, and
wherein the second SNR threshold is smaller than the first SNR threshold.

4. The method of claim 3, wherein (b) further comprises,
when the SNR value corresponding to the transport stream packet is smaller than the second SNR threshold, repeating the channel tuning the demodulating until the SNR value corresponding to the transport stream packet is larger than the second SNR threshold.

5. The method of claim 1, wherein (c) comprises:
(c1) generating an elementary stream by demultiplexing the transport stream packets output in (b); and
(c2) generating the video and audio data by decoding the elementary streams generated in (c1).

6. The method of claim 5, wherein (c) further comprises, before operation (c1),
(c3) determining whether errors exist in a corresponding transport stream packet based on a transport packet error indicator included in each transport stream packet, and
wherein in (c1), when the transport packet error indicator represents that the transport stream packet contains no error, the demultiplexing is performed on the transport stream packet.

7. The method of claim 5, wherein in (c2), the video and audio data is generated by decoding the elementary streams by using sequence headers included in the elementary streams.

8. A digital broadcasting receiver comprising:
a tuning and demodulating unit generating transport stream packets by tuning and demodulating a broadcasting signal of a broadcasting channel selected by a channel change instruction and outputting the transport stream packets before the completion of the channel tuning and demodulation of the broadcast signal;
a data processing unit generating video and audio data by demultiplexing and decoding the transport stream packets output from the tuning and demodulating unit; and
a reproducing unit reproducing the video and audio data,
wherein the digital broadcasting receiver starts screen mute in response to the channel change instruction and terminates the screen mute when a normal image display is possible by using the video data.

9. The digital broadcasting receiver of claim 8, wherein the tuning and demodulating unit comprises:
a tuner performing a tuning operation for the broadcasting channel selected by the channel change instruction and outputting the broadcasting signal of the broadcasting channel received by the tuning operation; and
a demodulator generating the transport stream packets by demodulating the broadcasting signal output from the tuner and outputting the transport stream packets before the completion of the channel tuning and demodulation of the broadcast signal.

10. The digital broadcasting receiver of claim 9,
wherein the demodulator outputs the transport stream packets even when an SNR value of a transport stream packet is smaller than a first SNR threshold, and
wherein the first SNR threshold is a reference value used to determine that channel tuning and demodulation of the broadcast signal has been completed.

11. The digital broadcasting receiver of claim 10,
wherein the demodulator comprises an SNR comparator which compares the SNR value of the transport stream packet with a second SNR threshold which is smaller than the first SNR threshold, and
wherein the demodulator outputs the transport stream packets to the data processing unit after the SNR value corresponding to the transport stream packet is larger than the second SNR threshold according to the result of the comparing of the SNR comparator.

12. The digital broadcasting receiver of claim 11, wherein, when the result of the comparing of the SNR comparator shows that the SNR value corresponding to the transport stream packet is smaller than the second SNR threshold, the tuning and demodulating unit repeats the channel tuning and demodulating until the SNR value corresponding to the transport stream packet is larger than the second SNR threshold.

13. The digital broadcasting receiver of claim 8, wherein the data processing unit comprises:
a demultiplexer generating an elementary stream by demultiplexing the transport stream packets output from the tuning and demodulating unit; and
video and audio processing units generating video and audio data by decoding the elementary streams generated by the demultiplexer.

14. The digital broadcasting receiver of claim 13,
wherein the demultiplexer generates the elementary stream by demultiplexing a transport stream based on a transport packet error indicator included in the transport stream, and
wherein the demultiplexer performs demultiplexing on the transport stream packet including the transport packet error indicator when the transport packet error indicator represents that the transport stream packet contains no error.

15. The digital broadcasting receiver of claim 8, wherein the data processing unit generates the video and audio data by decoding the elementary streams by using sequence headers included in the elementary streams.

16. A method of switching a channel in a digital broadcasting receiver, the method comprising:
generating transport stream packets by channel tuning and demodulating a broadcasting signal of a channel selected by the channel change instruction;
outputting the transport stream packets before completion of tuning and demodulating of the broadcast signal; and
generating video and/or audio data by demultiplexing and decoding the outputted transport stream packets.

17. The method of switching a channel in a digital broadcast receiver according to the claim 16, wherein the completion of the tuning and demodulating of the broadcast signal occurs when the signal to noise ratio of the transport stream packets are greater than a first signal to noise ratio threshold value.

18. The method of switching a channel in a digital broadcast receiver according to the claim 16, wherein outputting the transport stream packets occurs when the signal to noise ratio threshold value is greater than a second signal to noise ratio threshold value, the second signal to noise ratio threshold value being less than the first signal to noise ratio threshold value.

19. The method of switching a channel in a digital broadcast receiver according to the claim 18, wherein the second signal to noise ratio threshold value is equal to substantially zero.

20. The method of switching a channel in a digital broadcast receiver according to the claim 18, wherein the first signal to noise ratio threshold value is equal to substantially 30 db.

21. The method of switching a channel in a digital broadcast receiver according to the claim 18, wherein the second signal to noise ratio threshold value is less than 25 db.

22. The method of switching a channel in a digital broadcast receiver according to the claim 21, wherein the second signal to noise ratio threshold value is less than 20 db.

23. The method of switching a channel in a digital broadcast receiver according to the claim 22, wherein the second signal to noise ratio threshold value is less than 15 db.

24. The method of switching a channel in a digital broadcast receiver according to the claim 23, wherein the second signal to noise ratio threshold value is less than 10 db.
